(19) United States
(12) Patent Application Publication
(10) Pub. No.: US 2007/0180329 A1
(43) Pub. Date: Aug. 2, 2007

(54) Method of latent fault checking a management network

(76) Inventors: Mark S. Lanus, Tempe, AZ (US); Wolfgang Poschenrieder, Zorneding (DE); Fedor Solodovnik, Neubiberg (DE)

Correspondence Address: MOTOROLA, INC., LAW DEPARTMENT, 1303 E. ALGONQUIN ROAD, SCHAUMBURG, IL, 60196, US

(21) Appl. No.: 11/344,450

(22) Filed: Jan. 31, 2006

(51) Int. Cl. G06F 11/00

(52) U.S. Cl. 714/42

(57) ABSTRACT

A method of latent fault checking a management network may include a management bus communicating management data for a computing module on the management network; a management controller managing the computing module; a master management controller operating the management bus; and a buffer module between the management bus and each of the management controller and the master management controller, where the buffer module is coupled to provide isolation for each of the management controller and the master management controller from the management bus. Prior to an active fault in the management network, a latent fault checking module is executed on the buffer module to determine if the latent fault checking module detects a latent fault on the buffer module.

### BACKGROUND OF INVENTION

A management bus, such as an Intelligent Platform Management Bus (IPMB), may be used to manage computer modules in a modular computer system. A management controller, for example an Intelligent Platform Management Controller (IPMC), may be used to operate the management bus. In the prior art, a buffer is used to isolate a failed management controller from the management bus to free up the management bus for use by other management controllers. This provides for fault containment for management controller failures. However, in the prior art, it is possible for the buffer to fail in such a way that it no longer provides isolation from the management bus. This type of failure may not be detected until a second management controller failure, at which time the buffer is needed to provide fault isolation and containment for the management bus. The prior art is deficient in detecting a management controller buffer failure prior to the buffer actually being needed to provide isolation. This has the disadvantage of providing a decreased level of fault containment, fault recovery, and reliability in a computer system.

There is a need, not met in the prior art, of a method and apparatus to allow detection of a management controller buffer fault prior to the buffer actually being needed to contain a management controller fault. Accordingly, there is a significant need for an apparatus that overcomes the deficiencies of the prior art outlined above.

### BRIEF DESCRIPTION OF THE DRAWINGS

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent in light of certain exemplary embodiments recited in the Detailed Description, wherein:

FIG. 1 representatively illustrates computer system in accordance with an exemplary embodiment of the present invention;

FIG. 2 representatively illustrates a logical representation of a computer system in accordance with an exemplary embodiment of the present invention;

FIG. 3 representatively illustrates a logical representation of a computer system in accordance with an exemplary embodiment of the present invention; and

FIG. 4 representatively illustrates flow diagram of an exemplary method in accordance with an exemplary embodiment of the present invention.

Elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms “first”, “second”, and the like herein, if any, are used inter alia for distinguishing between similar elements and not necessarily for describing a sequential or chronological order. Moreover, the terms “front”, “back”, “top”, “bottom”, “over”, “under”, and the like in the Description and/or in the Claims, if any, are generally employed for descriptive purposes and not necessarily for comprehensively describing exclusive relative position. Any of the preceding terms so used may be interchanged under appropriate circumstances such that various embodiments of the invention described herein may be capable of operation in other configurations and/or orientations than those explicitly illustrated or otherwise described.

### DETAILED DESCRIPTION OF EXEMPLARY EMBODIMENTS

The following representative descriptions of the present invention generally relate to exemplary embodiments and the inventor's conception of the best mode, and are not intended to limit the applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

Software blocks that perform embodiments of the present invention can be part of computer program modules comprising computer instructions, such control algorithms that are stored in a computer-readable medium such as memory. Computer instructions can instruct processors to perform any methods described below. In other embodiments, additional modules could be provided as needed.

A detailed description of an exemplary application is provided as a specific enabling disclosure that may be generalized to any application of the disclosed system, device and method for latent fault checking of a management network in accordance with various embodiments of the present invention.

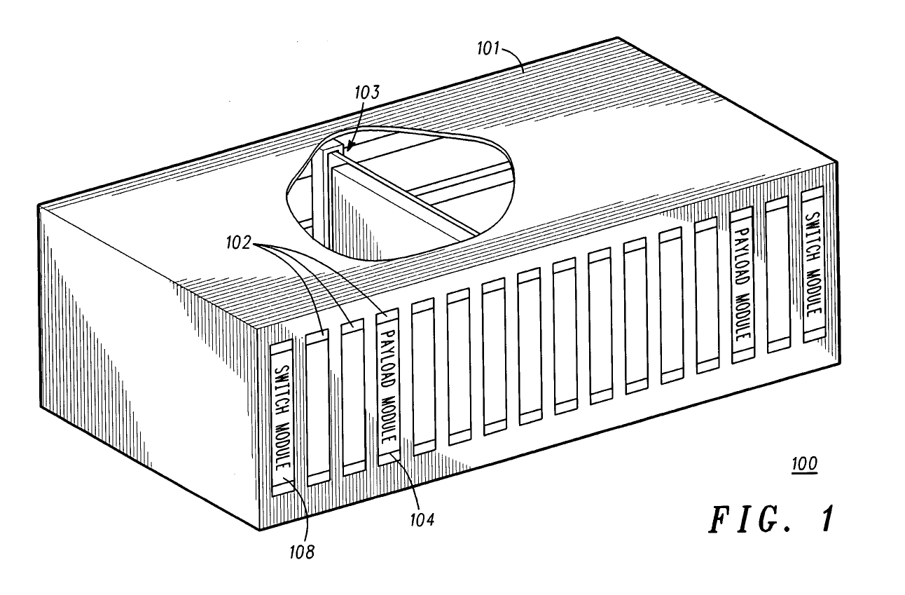

FIG. 1 representatively illustrates computer system 100 in accordance with an exemplary embodiment of the present invention. As shown in FIG. 1, computer 100 may include an embedded computer chassis 101 having a backplane 103, with software and a plurality of slots 102 for inserting modules, for example, switch modules 108 and payload modules 104.

Backplane 103 may be used for coupling modules placed in plurality of slots 102 to facilitate data transfer and power distribution. In an embodiment, backplane 103 may comprise for example and without limitation, 100-ohm differential signaling pairs.

As shown in FIG. 1, computer system 100 may comprise at least one switch module 108 coupled to any number of payload modules 104 via backplane 103. Backplane 103 may accommodate any combination of a packet switched backplane including a distributed switched fabric, or a multi-drop bus type backplane. Bussed backplanes may include CompactPCI, Advanced Telecom Computing Architecture (AdvancedTCA), MIcroTCA, and the like.

Payload modules 104 may add functionality to computer system 100 through the addition of processors, memory, storage devices, I/O elements, and the like. In other words, payload module 104 may include any combination of processors, memory, storage devices, I/O elements, and the like, to give computer system 100 any functionality desired by a user. Carrier cards are payload cards that are designed to have one or more mezzanine cards plugged into them to add even more modular functionality to the computer system. Mezzanine cards are different from payload cards in that mezzanine cards are not coupled to physically connect directly with the backplane, whereas payload cards function to physically directly connect with the backplane.

In the embodiment shown, there are sixteen slots 102 to accommodate any combination of switch modules 108 and payload modules 104. However, a computer system 100 with any number of slots, including a motherboard-based system with no slots, may be included in the scope of the invention.

In an embodiment, computer system 100 can use switch module 108 as a central switching hub with any number of payload modules 104 coupled to switch module 108. Computer system 100 may support a point-to-point, switched input/output (I/O) fabric. Computer system 100 may be implemented by using one or more of a plurality of switched fabric network standards, for example and without limitation, InfiniBand™, Serial RapidIO™, Ethernet™, AdvancedTCA™, PCI Express™, Gigabit Ethernet, and the like. Computer system 100 is not limited to the use of these switched fabric network standards and the use of any switched fabric network standard is within the scope of the invention.

In an embodiment, computer system 100 and embedded computer chassis 101 may comply with the Advanced Telecom and Computing Architecture (ATCA™) standard as defined in the PICMG 3.0 AdvancedTCA specification, where switch modules 108 and payload modules 104 are used in a switched fabric. In another embodiment, computer system 100 and embedded computer chassis 101 may comply with CompactPCI standard. In yet another embodiment, computer system 100 and embedded computer chassis 101 may comply with the MicroTCA standard as defined in PICMG® MicroTCA.0 Draft 0.6—Micro Telecom Compute Architecture Base Specification (and subsequent revisions). The embodiment of the invention is not limited to the use of these standards, and the use of other standards is within the scope of the invention.

In the MicroTCA implementation of an embodiment, computer system 100 is a collection of interconnected elements including at least one Advanced Mezzanine Card (AMC) module (analogous to the payload module 104), at least one virtual carrier manager (VCM) (analogous to the switch module 108) and the interconnect, power, cooling and mechanical resources needed to support them. A typical prior art MicroTCA system may consist of twelve AMC modules, one (and optionally two for redundancy) virtual carrier managers coupled to a backplane 103. AMC modules are specified in the Advanced Mezzanine Card Base Specification (PICMG® AMC.0 RC1.1 and subsequent revisions). VCM's are specified in the MicroTCA specification—MicroTCA.0 Draft 0.6—Micro Telecom Compute Architecture Base Specification (and subsequent revisions).

AMC modules can be single-width, double-width, full-height, half-height modules or any combination thereof as defined by the AMC specification. A VCM acts as a virtual carrier card which emulates the requirements of the carrier card defined in the Advanced Mezzanine Card Base Specification (PICMG® AMC.0 RC1.1) to properly host AMC modules. Carrier card functional requirements include power delivery, interconnects, Intelligent Platform Management Interface (IPMI) management, and the like. VCM combines the control and management infrastructure, interconnect fabric resources and the power control infrastructure for the AMC modules into a single unit. A VCM comprises these common elements that are shared by all AMC modules and is located on the backplane 103, on one or more AMC modules, or a combination thereof.

FIG. 2 representatively illustrates a logical representation of a computer system 200 in accordance with an exemplary embodiment of the present invention. Computer system 200 may include a computing module 202, which may represent any of a switch module, payload module, AMC module, VCM, and the like as shown and described above.

Coupled to computing module 202, is a master management controller 216, which may function to control a management bus 218. In an embodiment, management bus 218 may communicate management data 222 between master management controller 216 and a management controller 214. Management data 222 may include information transmitted from computing module such as temperature, voltage, amperage, bus traffic, status indications, and the like of computer module 202. Management data 222 may also include information transmitted from master management controller 216 such as instructions for cooling fans, adjustment of power supplies, and the like. Management data 222 communicated over management bus 218 functions to monitor and maintain computing module 202. Management data 222 differs from other data transmitted on a data bus (not shown for clarity) in that management data 222 is used for monitoring and maintaining computing module 202, while a data bus functions to communicate data transmitted to/from and processed by computing module 202.

Computer system 200 may include one or more management controllers 214, which may function to monitor and manage one or more computing modules 202. For example, computer system 200 may include two management controllers 214 to facilitate monitoring and management of two computing modules 202 (one active and one standby). Management controller 214 may monitor status data (temperature, voltage, amperage, and the like) received form computing module 202 and provide management instructions to computing module 202 (increase/decrease cooling fan speed, turn on/off power, and the like). One or more management controllers 214 may be controlled by one or more master management controller 216 (only one master management controller active at any time). In an embodiment, master management controller 216 may operate as a master with one or more management controllers 214 operating as slaves. Master management controller 216 serves as master of management bus 218.

Computer system 200 may also include a buffer module 212 interposed between each management controller 214 and management bus 218. Buffer module 212 may also be interposed between each master management controller 216 and management bus 218. In an embodiment, buffer module 212 functions, among other things, to provide isolation between a management controller 214 or master management controller 216, respectively, and management bus 218. In the case of failure of management controller 214 or master management controller 216, buffer module 212 may operate as a switch and disconnect or isolate the failed management controller 214 or master management controller 216 from management bus 218. This allows communication to continue between some master management controller 216 and some management controllers 214 on the management bus 218, and thus ensures that a failed management controller 214 or master management controller 216 does not cause the entire management bus 218 to fail.

In an embodiment, management bus 218 may be an Intelligent Platform Management Bus (IPMB) as specified in an Intelligent Platform Management Interface Specification. The Intelligent Platform Management Bus may be an I²C-based bus that provides a standardized interconnection between different boards within a chassis. The IPMB can also serve as a standardized interface for auxiliary or emergency management add-in cards.

In an embodiment, management controller may be an Intelligent Platform Management Controller (IPMC). The term “platform management” is used to refer to the monitoring and control functions that are built in to the platform hardware and primarily used for the purpose of monitoring the health of the system hardware. This typically may include monitoring elements (management data 222) such as system temperatures, voltages, fans, power supplies, bus errors, system physical security, etc. It may include automatic and manually driven recovery capabilities such as local or remote system resets and power on/off operations. It may include the logging of abnormal or ‘out-of-range’ conditions for later examination and alerting where the platform issues the alert without aid of run-time software. It may also include inventory information that can help identify a failed hardware unit. In an embodiment, master management controller may be a Shelf Management Controller (ShMC) as is know in the AdvancedTCA computer platform.

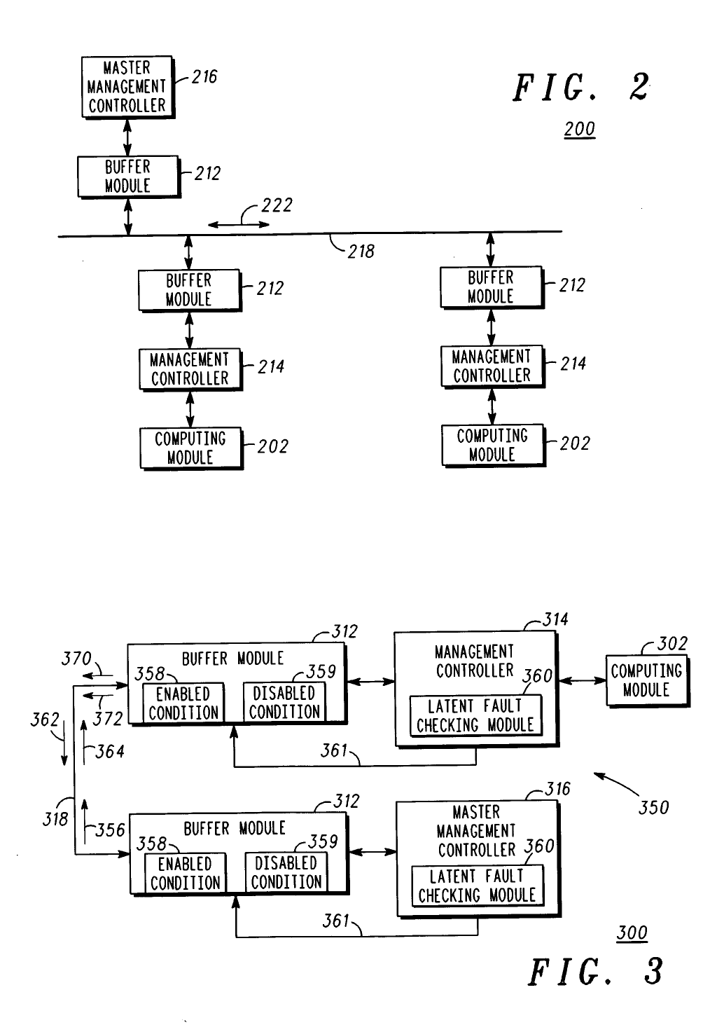

FIG. 3 representatively illustrates a logical representation of a computer system 300 in accordance with an exemplary embodiment of the present invention. The computer system 300 of FIG. 3 represents a management network 350, which may include one or more master management controllers 316, one or more buffer modules 312, management bus 318 and one or more management controllers 314. Management network 350 is coupled to monitor and control one or more computing modules 302 as described above. One or more master management controllers 316 are coupled to operate as a master (only one master management controller can be active at a time), with one or more management controllers 314 operating as slaves.

In an embodiment, a major mechanism for fault containment for the management network 350 is the buffer module 312, which is controlled by the management controller 314 or master management controller 316. Each master management controller 316 and management controller 314 may have its own buffer module 312 as shown. For example, if the management controller 314 or master management controller 316 fails so as to cause the management bus 318 to fail, the buffer module 312 may be used to isolate the failed management controller 314 or master management controller 316 from the management bus 318 so as to free up the management bus 318 for use by other management controllers.

In the prior art, when a buffer module 312 failed in the “closed” position (enabled), whereby the management controller 314 or master management controller 316 can still access the management bus 318, there was no protection or isolation from the management bus 318 if the associated management controller 314 or master management controller 316 failed. This is referred to as a latent fault as it is a failure of the buffer module 312, but does not cause the management bus 318 to fail. For the management bus 318 to fail, a second fault in the management network 350 must take place, for example a failure of the management controller 314 or master management controller 316. In other words, a latent fault is a fault that is present but not visible or active. In order to maintain a highly reliable, highly available system, a latent fault in buffer module 312 needs to be detected before the second fault occurs and activates the latent fault to the status of active fault. This is the function of latent fault checking module 360, which may be any combination of software or hardware functioning to detect a latent fault in buffer module prior to that latent fault manifesting itself as an active fault.

In an embodiment, prior to an active fault in management network 350, management controller 314 or master management controller 316 may manually disable or enable buffer module 312 via enabling circuit 361. In other words, management controller 314 or master management controller 316 may place buffer module 312 in a disabled condition 359 or an enabled condition 358. Disabled condition 359 is an “open” condition where management controller 314 or master management controller 316 is disconnected from management bus 318. Enabled condition 358 is a “closed” condition where management controller 314 or master management controller 316 is connected to management bus 318.

In an embodiment, master management controller 316 or management controller 114 may periodically initiate latent fault checking module 360 in management controller 314 or master management controller 316. For example, at regular intervals or randomly, master management controller 316 or management controller 314 may communicate an initiation signal 356 to management controller 314 or master management controller 316 to execute latent fault checking module 360.

Latent fault checking module 360 operates based on disabling buffer module 312, sending a latent fault check message 362 to another controller on the management bus 318, and seeing if acknowledge message 364 is received. In order for latent fault check message 362 to be sent, a bus address of the management controller 314 or master management controller 316 should be known. This may be done, for example and without limitation, by sending an initiation signal 356 to an active or standby management controller 314 from an active or standby master management controller 316, where initiation signal 356 instructs management controller 314 to begin latent fault checking module 360.

In another embodiment, for example and without limitation, master management controller 316 may test its own buffer module 312. In this embodiment, master management controller 316, for example, may send initiation signal 356 to management controller 314 and have management controller participate in the latent fault checking process, or broadcast to solicit a response from all management controllers 314 on management bus 318.

Other embodiments may include management controller 314 initiating latent fault checking module 360 on buffer module 312 connected to master management controller 316 or another management controller 314, and management controller 314 initiating latent fault checking module 360 on its own buffer module 312. Once initiation signal 356 is received, latent fault checking module 360 may be executed by testing buffer module 312 in the disabled condition 359.

In a first exemplary embodiment, latent fault checking module 360 may be initiated by master management controller 316 on the buffer module 312 connected to management controller 314. Master management controller 316 may request that management controller 314 place buffer module 312 in disabled condition 359. Once in disabled condition 359, management controller 314 may send a latent fault check message 362 to master management controller 316. If buffer module 312 is in disabled condition 359, then latent fault check message 362 cannot get though to management bus 318 and/or master management controller 316. In this case, an operative condition 372 is determined because buffer module 312 appears to be operating properly as it is in disabled condition 359 per instructions from management controller 314. If buffer module 312 is in enabled condition 358 (stuck in “closed” enabled condition 358 in this example), then latent fault check message 362 will reach management bus 318 and master management controller 316, which will return an acknowledge message 364 to management controller 314. In this case, a latent fault condition 370 is indicated as buffer module 312 appears to have a latent fault as buffer module 312 is not in disabled condition 359 (buffer module may be stuck “closed” in an enabled condition).

In a second exemplary embodiment, latent fault checking module 360 may be initiated by management controller 314 on the buffer module 312 connected to master management controller 316. Management controller 314 may request that master management controller 316 place buffer module 312 in disabled condition 359. Once in disabled condition 359, master management controller 316 may send a latent fault check message 362 to management controller 314. If buffer module 312 is in disabled condition 359, then latent fault check message 362 cannot get though to management bus 318 and/or management controller 314. In this case, an operative condition 372 is determined because buffer module 312 appears to be operating properly as it is in disabled condition 359 per instructions from master management controller 316. If buffer module 312 is in enabled condition 358 (stuck in “closed” enabled condition 358 in this example), then latent fault check message 362 will reach management bus 318 and management controller 314, which will return an acknowledge message 364 to master management controller 316. In this case, a latent fault condition 370 is indicated as buffer module 312 appears to have a latent fault as buffer module 312 is not in disabled condition 359 (buffer module may be stuck “closed” in an enabled condition).

In a third exemplary embodiment, latent fault checking module 360 may be executed by management controller 314, on its own buffer module 312. In this embodiment, management controller 314 may use another active or standby controller on management bus 318 to execute latent fault checking module 360. In an fourth exemplary embodiment, latent fault checking module 360 may be executed by master management controller 316 on its own buffer module 312. In this embodiment, master management controller 316 may use another active or standby controller on management bus 318 to execute latent fault checking module 360.

The above exemplary embodiments are representative and not limiting of the invention. Other embodiments conceived by one skilled in the art are within the scope of the invention.

In any of the above embodiments, once buffer module 312 is tested in the disabled condition 359, the status of buffer module 312 may be communicated to or inferred by master management controller 316 or management controller 314 (depending on the embodiment and the entity which initiated latent fault checking module 360). If a latent fault condition 370 is indicated at any time, then latent fault condition 370 may be communicated to or inferred by master management controller 316 or management controller 314. If no latent fault condition 370 is indicated, then an operative condition 372 may be communicated to or inferred by master management controller 316 or management controller 314. In an embodiment, if a latent fault condition 370 is detected, another management controller 314 or master management controller 316 may become active, while the entity associated with the latent fault is disabled (or switched to standby). Also, notification to a system administrator may be communicated so that the buffer module 312 with the latent fault condition 370 may be replaced or otherwise remedied.

In an embodiment, latent fault check message 362 may be an entire message or one or more bytes from a message. In a further embodiment, acknowledge message 364 may be an acknowledgment to an entire latent fault check message 362 or one or more bytes of a latent fault check message 362. In yet another embodiment, acknowledge message 364 may include manipulating of management bus 318, for example, setting digital output to logic “1” or logic “0.” If the management bus 318 is in a logic “0” or logic “1” long enough, a protocol error will be detected by other active entities (controllers) on the management bus 318.

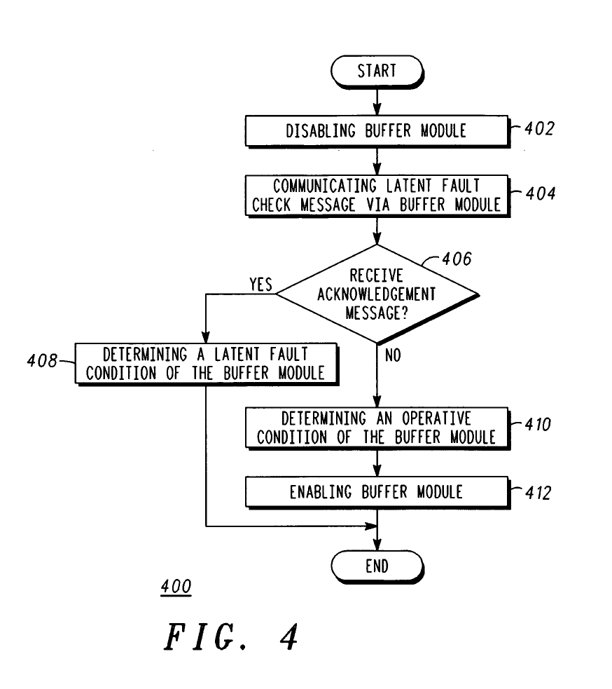

FIG. 4 representatively illustrates flow diagram 400 of an exemplary method in accordance with an exemplary embodiment of the present invention. The method depicted in FIG. 4 illustrates the execution of latent fault checking module 360 as initiated by master management controller on management, controller, but applies to any of the above embodiments.

In step 402, buffer module is disabled by placing it in a disabled condition. In step 404, latent fault check message is communicated via buffer module. In step 406 it is determined if an acknowledge message is received in response to the latent fault check message. If not, an operative condition of the buffer module is determined per step 410. If an acknowledgment message is received, a latent fault condition is determined per step 408. In step 412, buffer module is optionally enabled by placing it in an enabled condition.

Subsequent to testing buffer module in disabled condition, the result may be communicated to or inferred by master management controller and remedial action taken as necessary by mater management controller (switching management controller to standby status), and/or a system administrator (repairing or replacing module containing management controller).

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above.

For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

We claim:

1. A method of latent fault checking a management network, comprising:
providing a management bus communicating management data for a computing module on the management network;
providing a management controller managing the computing module;
providing a master management controller operating the management bus;
providing a buffer module between the management bus and each of the management controller and the master management controller, wherein the buffer module is coupled to provide isolation for each of the management controller and the master management controller from the management bus;
prior to an active fault in the management network, executing a latent fault checking module on the buffer module; and
determining if the latent fault checking module detects a latent fault on the buffer module.

2. The method of claim 1, further comprising the master management controller initiating the latent fault checking module for the buffer module.

3. The method of claim 1, further comprising the management controller initiating the latent fault checking module for the buffer module.

4. The method of claim 1, wherein the latent fault checking module comprising:
disabling the buffer module;
communicating a latent fault check message via the buffer module.

5. The method of claim 4, wherein with the buffer module in a disabled condition:
if an acknowledge message is received in response to the latent fault check message, determining a latent fault condition of the buffer module, and wherein if the acknowledge message is not received in response to the latent fault check message, determining an operative condition of the buffer module.

6. The method of claim 1, wherein the latent fault checking module is performed on the buffer module connected to the master management controller.

7. The method of claim 1, wherein the latent fault checking module is performed on the buffer module connected to the management controller.

8. The method of claim 1, wherein the management bus is an Intelligent Platform Management Bus (IPMB).

9. The method of claim 1, wherein the management controller is an Intelligent Platform Management Controller (IPMC).

10. A latent fault checking module coupled to be executed by one of a management controller operating a management bus and a master management controller, the latent fault checking module comprising:
disabling a buffer module, wherein the buffer module is coupled to provide isolation between the management bus and one of the management controller and the master management controller;
communicating a latent fault check message via the buffer module; and
with the buffer module in a disabled condition, if an acknowledge message is received in response to the latent fault check message, determining a latent fault condition of the buffer module, and wherein if the acknowledge message is not received in response to the latent fault check message, determining an operative condition of the buffer module.

11. The latent fault checking module of claim 10, wherein the latent fault checking module is executed on the buffer module connected to the master management controller.

12. The latent fault checking module of claim 10, wherein the latent fault checking module is executed on the buffer module connected to the management controller.

13. The latent fault checking module of claim 10, wherein the management bus is an Intelligent Platform Management Bus (IPMB).

14. The latent fault checking module of claim 10, wherein the management controller is an Intelligent Platform Management Controller (IPMC).

15. A computer system having a computing module, the computer system comprising:
a management bus, wherein the management bus communicates management data for the computing module;
a master management controller coupled to operate the management bus;
a management controller coupled to operate the computing module;
a buffer module interposed between the management bus and each of the management controller and the master management controller, wherein the buffer module is coupled to provide isolation for each of the management controller and the master management controller from the management bus; and
a latent fault checking module coupled to be executed by one of the management controller and the master management controller, wherein prior to an active fault, the latent fault checking module executing the steps of:
disabling the buffer module;
communicating a latent fault check message via the buffer module; and
with the buffer module in a disabled condition, if an acknowledge message is received in response to the latent fault check message, determining a latent fault condition of the buffer module, and wherein if the acknowledge message is not received in response to the latent fault check message, determining an operative condition of the buffer module.

16. The computer system of claim 15, wherein the latent fault checking module is executed on the buffer module connected to the master management controller.

17. The computer system of claim 15, wherein the latent fault checking module is executed on the buffer module connected to the management controller.

18. The computer system of claim 15, wherein the management bus is an Intelligent Platform Management Bus (IPMB).

19. The computer system of claim 15, wherein the management controller is an Intelligent Platform Management Controller (IPMC).

20. The computer system of claim 15, wherein the master management controller is a shelf management controller.
